(19) United States
(12) Patent Application Publication
(10) Pub. No.: US 2026/0249318 A1
(43) Pub. Date: Aug. 27, 2026

(54) MAGNETIC SHOWER ASSEMBLY

(71) Applicant: Kohler Co., Kohler, WI (US)

(72) Inventors: Hiroyuki Chanseol Muraoka, New York, NY (US); Lun Cheak Tan, Sheboygan, WI (US); Feiying Su, Shanghai (CN)

(73) Assignee: Kohler Co., Kohler, WI (US)

(21) Appl. No.: 18/714,356

(22) PCT Filed: Nov. 22, 2022
(86) PCT No.: PCT/CN2022/133523

§ 371 Date: May 29, 2024

Related U.S. Application Data
(60) Provisional application No. 63/284,453, filed on Nov. 30, 2021.

(51) Int. Cl. B05B 15/62; A47K 3/28; B05B 15/63

(52) U.S. Cl. CPC B05B 15/62; A47K 3/28; B05B 15/63; A47K 2201/00

(57) ABSTRACT

A spray head for a shower assembly includes a front portion having a spray face, a rear portion opposite the spray face that includes a magnetic region. The magnetic region includes a plurality of magnetic angled surfaces configured to magnetically couple the spray head to a support surface at a plurality of different angles. The spray head also includes a slot defined within the magnetic region, the slot configured to accommodate a fluid conduit therein.

### CROSS-REFERENCE TO RELATED APPLICATIONS

This application is the U.S. national stage of International Patent Application No. PCT/CN2022/133523 filed Nov. 22, 2022, which claims the benefit of and priority to U.S. Provisional Patent Application No. 63/284,453 filed Nov. 30, 2021, both of which are incorporated by reference herein in their entireties.

### BACKGROUND

The present disclosure relates generally to the field of handshower shower assemblies. More specifically, this disclosure relates to a magnetic handshower assembly to facilitate ease of use and customization of the assembly configuration.

Shower assemblies may include a handheld shower wand or device in addition to or in place of a mounted showerhead. Although the mounted showerhead provides for a hands free showering experience and the handheld shower wand enables greater range of spray, neither setup allows for a user to customize both translational and angular spray angles within the shower, while also maintaining a hands free experience by the user.

Accordingly, it would be advantageous to provide a shower assembly that provides for adjustable and customizable positioning of a shower head, while preserving both handheld and hands free functionality.

### SUMMARY

One aspect of the present disclosure relates to a spray head for a shower assembly. The spray head includes a front portion having a spray face and a rear portion opposite the spray face, where the rear portion includes a magnetic region. The magnetic region includes a plurality of magnetic angled surfaces configured to magnetically couple the spray head to a support surface at a plurality of different angles. The spray head also includes a slot defined within the magnetic region, where the slot is configured to accommodate a fluid conduit therein.

In various embodiments, the magnetic region includes a first portion and a second portion, where the first portion is disposed on a first side of the slot and the second portion is disposed on a second side of the slot. In some embodiments, the spray head also includes a body coupled to the spray face, where the magnetic region is disposed within the body. In other embodiments, the body includes at least one grip-enhancing overlay configured to facilitate ease of handling of the spray head. In yet other embodiments, the spray head also includes a handle, wherein the handle is rotatably coupled to the body. In various embodiments, the handle is retractable into the slot.

Another aspect of the present disclosure relates to a shower assembly. The shower assembly includes at least one magnetic panel configured for coupling to at least one support surface within a shower area, a water supply, and a spray head fluidly coupled to the water supply via one or more fluid conduits. The spray head includes a magnetic region including a plurality of angled surfaces, where each of the angled surfaces configured to magnetically couple to the at least one magnetic panel. The spray head also includes a slot defined within the magnetic region, where the slot is configured to accommodate the one or more fluid conduits therein.

In various embodiments, the magnetic region further comprises a first portion and a second portion, the first portion disposed on a first side of the slot and the second portion disposed on a second side of the slot. In some embodiments, the spray head further includes a body and a handle, where the magnetic region is disposed within the body, and where the handle is rotatably coupled to the body between the first portion and the second portion of the magnetic region. In other embodiments, the spray head includes a front portion having one or more water outlets and a rear portion opposite the front portion, where the magnetic region is disposed within the rear portion. In yet other embodiments, the handle is arcuate. In various embodiments, the handle is configured to retract into the body of the spray head. In some embodiments, the at least one magnetic panel includes a first magnetic panel and a second magnetic panel. In other embodiments, the first magnetic panel is mounted in a vertical orientation and the second magnetic panel is mounted in a horizontal orientation. In yet other embodiments, at least one support surface includes a first support surface and a second support surface, where the first magnetic panel is coupled to the first support surface and the second magnetic panel is coupled to the second support surface.

In various embodiments, the shower assembly includes a support member structurally separate from both the at least one magnetic panel and the spray head and configured to The support member includes a first portion extending away from the at least one magnetic panel when the support member is magnetically attached to the at least one magnetic panel, where the first portion is magnetic and is configured to magnetically couple to the spray head. The support member also includes a second portion attached to the first portion and includes at least one magnet configured to couple the second portion to the at least one magnetic panel. In various embodiments, the second portion includes a first prong and a second prong spaced from the first prong, where a gap between the first prong and the second prong is configured to accommodate the one or more fluid conduits therein. In some embodiments, the first portion is angled relative to the second portion such that a first end of the first portion is at a greater height than a height of a second end of the first portion when the support member is magnetically attached to the at least one magnetic panel, the second end being coupled to the second portion.

Yet another aspect of the present disclosure relates to a shower assembly. The shower assembly includes at least one magnetic panel configured for coupling to at least one support surface within a shower area, a water supply, and a spray head fluidly coupled to the water supply via one or more fluid conduits. The spray head includes a magnetic region having a plurality of angled surfaces, where each of the angled surfaces configured to magnetically couple to the at least one magnetic panel, and an arm extending between the magnetic region and a rear face of the spray head.

In various embodiments, a space between the magnetic region and the rear face is configured to accommodate the one or more fluid conduits therein.

### BRIEF DESCRIPTION OF THE DRAWINGS

The disclosure will become more fully understood from the following detailed description, taken in conjunction with the accompanying figures, wherein like reference numerals refer to like elements.

FIG. 1 is a front view of a handshower assembly in a first configuration, according to an exemplary embodiment.

FIG. 2 is a front view of the handshower assembly of FIG. 1 in a second configuration, according to an exemplary embodiment.

FIG. 3 is a perspective view of the handshower assembly of FIG. 1 in a third configuration, according to an exemplary embodiment.

FIG. 4 is a perspective view of the handshower assembly of FIG. 1 including removable shelving units, according to an exemplary embodiment.

FIG. 5 is a perspective view of the removable shelving units of FIG. 4, according to an exemplary embodiment.

FIG. 6 is a perspective view of the handshower assembly of FIG. 1 including a removable support member, according to an exemplary embodiment.

FIG. 7 is a side view of the handshower assembly of FIG. 6, according to an exemplary embodiment.

FIG. 8 is a side perspective view of the removable support member of FIG. 6, according to an exemplary embodiment.

FIG. 9 is a side perspective view of a spray head within the handshower assembly of FIG. 1 coupled to a support surface in a first configuration, according to an exemplary embodiment.

FIG. 10 is a rear perspective view of the spray head of FIG. 9, according to an exemplary embodiment.

FIG. 11 is a side perspective view of the spray head of FIG. 9 coupled to a support surface in a second configuration, according to an exemplary embodiment.

FIG. 12 is a front perspective view of the spray head of the handshower assembly of FIG. 1, according to an exemplary embodiment.

FIG. 13 is a rear perspective view of the spray head of FIG. 12, according to an exemplary embodiment.

FIG. 14 is a side cross-sectional view of the spray head of FIG. 12, according to an exemplary embodiment.

FIG. 15 is a front view of a spray head compatible with the handshower assembly of FIG. 1, according to an exemplary embodiment.

FIG. 16 is a side view of the spray head of FIG. 15, according to an exemplary embodiment.

FIG. 17 is a rear view of the spray head of FIG. 15, according to an exemplary embodiment.

FIG. 18 is a side view of the spray head of FIG. 15 coupled to a support surface, according to an exemplary embodiment.

FIG. 19 is a side perspective view of the spray head of FIG. 15, according to another exemplary embodiment.

FIG. 20 is a front view of the spray head of FIG. 19, according to an exemplary embodiment.

FIG. 21 is a rear view of the spray head of FIG. 19, according to an exemplary embodiment.

FIG. 22 is a perspective view of a support member assembly compatible with the handshower assembly of FIG. 1, according to an exemplary embodiment.

FIG. 23 is a perspective view of a hook support member of the support member assembly of FIG. 22, according to an exemplary embodiment.

FIG. 24 is a perspective view of a lower portion of a bracket support member of the support member assembly of FIG. 22, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

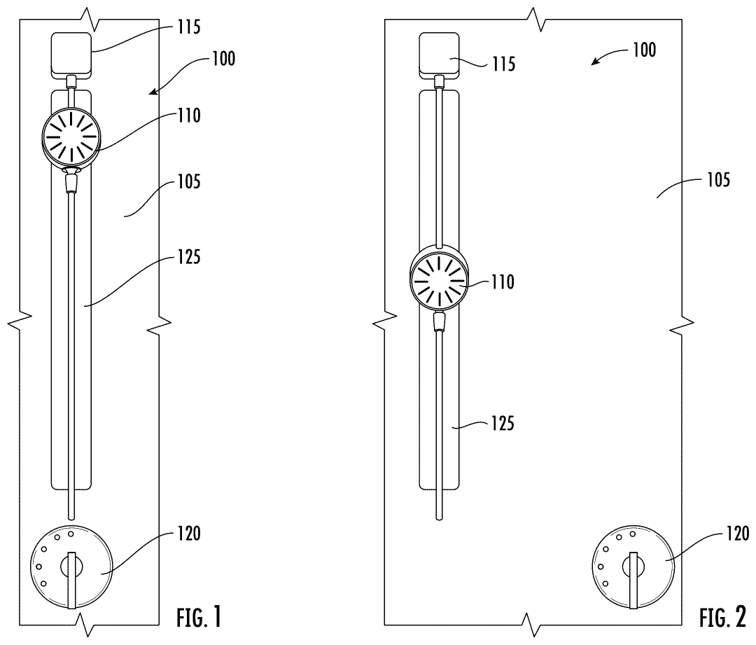

Referring to FIGS. 1 and 2, a handshower assembly 100 is shown, according to various exemplary embodiments. The handshower assembly 100 may be configured for use within a shower area having one or more support surfaces 105 (e.g., wall, joist, ceiling, etc.). The handshower assembly 100 includes at least one water outlet or spray head 110, which is fluidly coupled to a water supply 115, where the spray head 110 and the water supply 115 are coupled to the one or more support surfaces 105, and where the water supply 115 (and thus water flow and/or temperature through the at least one spray head 110) is controlled by a manual or automatic controller 120. The handshower assembly 100 includes one or more magnetic panels 125, which are directly coupled to the one or more support surfaces 105 and are configured to facilitate coupling of the at least one spray head 110 to the one or more support surfaces 105.

In various embodiments, the relative position of the water supply 115 to the one or more magnetic panels 125 may be adjustable. For example, as shown in FIG. 1, the water supply 115 may be disposed above the magnetic panel 125, which is further disposed above the controller 120, where each of the water supply, magnetic panel 125, and controller 120 are substantially axially aligned. Alternatively, as shown in FIG. 2, the water supply 115 and the magnetic panel 125 may be axially aligned, whereas the controller 120 is offset from the axis shared by the water supply 115 and the magnetic panel 125.

In various embodiments, the one or more magnetic panels 125 may include one or more magnetic materials (e.g., one or more ferrous components, or alloys). The one or more magnetic panels 125 may be configured as substantially plate-like in structure, with a thickness to width ratio of 0.1 or less. Although FIGS. 1 and 2 show the one or more magnetic panels 125 as being substantially rectangular in shape, the magnetic panels 125 may be configured as generally circular, ellipsoidal, rounded rectangular, or any other suitable shape. As described above, each of the one or more magnetic panels 125 is configured for directly coupling to the one or more support surfaces 105 within the shower area (e.g., via one or more fasteners). The at least one spray head 110 is configured to include one or more magnets or magnetic components, which are then configured for coupling to the one or more magnetic panels 125. Accordingly, as shown in FIGS. 1 and 2 the at least one spray head 110 may be adjustable within the handshower assembly 100 by simply decoupling the spray head 110 from one position on the magnetic panel 125 and recoupling at a second position on the magnetic panel 125. For example, as shown in FIG. 1, the spray head 110 is coupled near an upper portion of the magnetic panel 125, whereas FIG. 2 shows the spray head 110 coupled near a middle portion of the magnetic panel 125. Although FIGS. 1 and 2 show the magnetic panel 125 being arranged such that terminal ends of the panel 125 are axially stacked so that the panel 125 is substantially vertically oriented, the magnetic panel 125 may be coupled to the one or more support surfaces 105 in any suitable arrangement to facilitate adjustability of the spray head 110 within the assembly 100. For example, a vertical orientation of the magnetic panel 125 may facilitate vertical adjustment of the spray head 110, whereas a horizontal orientation of the magnetic panel may facilitate horizontal adjustment of the spray head.

In various embodiments, the handshower assembly 100 may include multiple magnetic panels, which are configured to be positioned on multiple support surfaces within a shower area. For example, as shown in FIG. 3, the handshower assembly 100 includes a first magnetic panel 125, which is coupled to a first support surface 105, and a second magnetic panel 130, which is coupled to a second support surface 107. Accordingly, the spray head 110 may be configured for coupling to more than one support surface and adjustable in multiple directions within the same shower space. In various embodiments, the first magnetic panel 125 may be arranged in a substantially vertical orientation, whereas the second magnetic panel 130 may be arranged in a substantially horizontal orientation. In some embodiments, magnetic panels may be arranged at different heights to facilitate ease of use by users of different sizes or abilities within the same shower space. For example, as shown in FIG. 3, the second magnetic panel 130 may be coupled to the support surface 107 at a height equal to or lower than a lower end of the first magnetic panel 125. Accordingly, a user may couple the spray head 110 to the second magnetic panel 130 to provide a relatively lower showering height (e.g., for use by children, wheelchair users, seated users, etc.) or the user may couple the spray head 110 to the first magnetic panel 125 to provide a relatively higher showering height (e.g., for use by taller individuals, adults, etc.). Although FIG. 3 shows only two magnetic panels 125, 130, the handshower assembly 100 may include any number of magnetic panels arranged within the shower area. In some embodiments, the water supply 115 may include a magnetic housing such that the spray head 110 is configured for coupling to the housing of the water supply 115.

In various embodiments, the handshower assembly 100 may also include one or more structural members, each having one or more magnets or magnetic components, which may be configured for coupling to the one or more magnetic panels. As shown in FIG. 4, the handshower assembly 100 may include one or more shelving units, which may be configured for removably coupling within the shower area. For example, the handshower assembly 100 may include a first shelving unit 135, which may be coupled to the magnetic panel 125. The handshower assembly 100 may also include a second shelving unit 140, which may be coupled to a magnetic panel 137. Although FIG. 4 shows the magnetic panel 125 disposed above the controller 120 and the magnetic panel 137 disposed below the controller 120, the magnetic panels 125, 137 may be configured for coupling within the shower area in any desired configuration. Furthermore, although FIG. 4 shows the shelving units 135, 140 respectively coupled to the magnetic panels 125, 137, the shelving units 135, 140 may be interchangeably coupled among the magnetic panels 125, 130, and/or 137. Moreover, although FIG. 4 shows only two shelving units 135, 140, the handshower assembly 100 may include any number of shelving units.

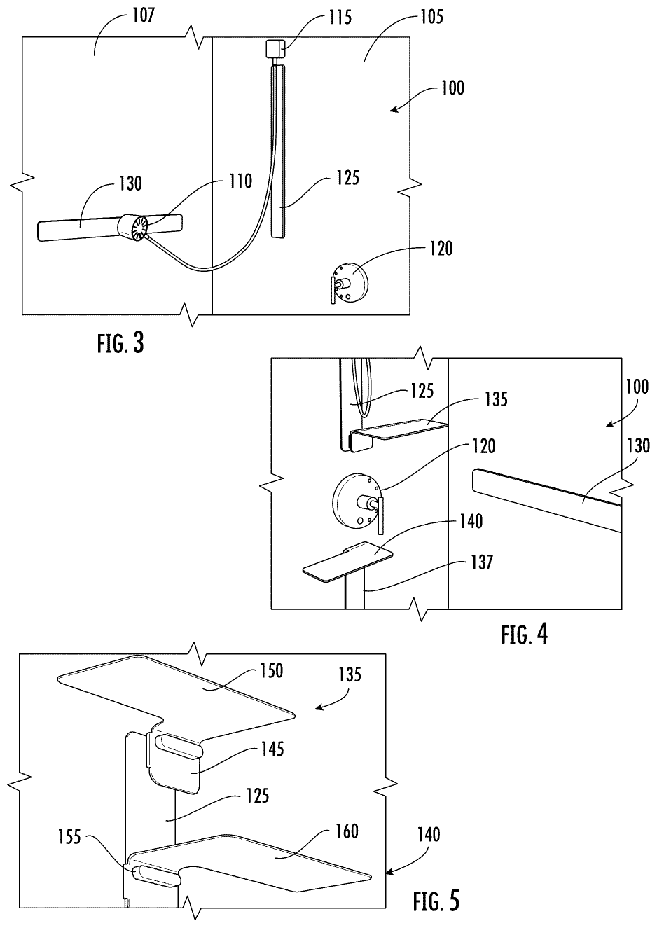

Each of the shelving units includes a magnetic portion and a non-magnetic portion, where the magnetic portion facilitates coupling to the one or more magnetic panels within the shower area and the non-magnetic portions facilitate storage or support. As shown in FIG. 5, the first shelving unit 135 includes a magnetic portion 145, which is coupled to and disposed substantially perpendicular to a non-magnetic portion 150, where the non-magnetic portion 150 is configured as a plate-like surface to allow for placement and/or storage of one or more items thereon. Similarly, the second shelving unit 140 includes a magnetic portion 155, which is substantially perpendicular to a non-magnetic portion 160, where the non-magnetic portion 160 is configured as a plate-like surface to allow for placement and/or storage of one or more items thereon. In various embodiments, the non-magnetic portions 150, 160 may be arranged such that the center axes of the non-magnetic portions 150, 160 are respectively offset from the center axes of the magnetic portions 145, 155. For example, as shown in FIG. 5, the non-magnetic portion 150 is offset from the magnetic portion 145 so that the non-magnetic portion 150 extends to a side (e.g., left side) of the magnetic portion 145. Similarly, the non-magnetic portion 160 is offset from the magnetic portion 155 so that the non-magnetic portion 160 extends to a side (e.g., right side) of the magnetic portion. In various embodiments, each of the non-magnetic portions 150, 160 may be substantially rectangular in shape, each having a first end and a second, opposite end. Accordingly, in some embodiments, the non-magnetic portions 150 may be coupled to the magnetic portion 145 at either the first or second end, and the non-magnetic portion 160 may be coupled to the magnetic portion 155 at either of its first end or second end. In various embodiments, the non-magnetic portions 150, 160 may be configured for separately coupling to the magnetic portions 145, 155, respectively. In other embodiments, the non-magnetic portions 150, 160 may be integrally forced with the magnetic portions 145, 155, respectively.

In various embodiments, the handshower assembly 100 may include one or more removable, magnetic support members. As shown in FIG. 6, the handshower assembly 100 includes a magnetic support member 165, which is configured for coupling to the magnetic panel 125. The handshower assembly 100 may include a second spray head 170 (configured to be similar or equivalent to the spray head 110) in addition to the spray head 110, where the spray head 170 is fluidly coupled to the water supply 115. Accordingly, the spray head 170 may be configured for coupling to the support member 165 while the spray head 110 remains configured for coupling to the magnetic panel 125. In this manner, the handshower assembly 100 may be adjustable and customizable to provide more than one water outlet, each being repositionable within the shower area. However, it should be noted that although FIG. 6 shows two spray heads 110 and 170, the handshower assembly 100 may be configured to have only one spray head (e.g., spray head 110 or spray head 170) or more than two spray heads.

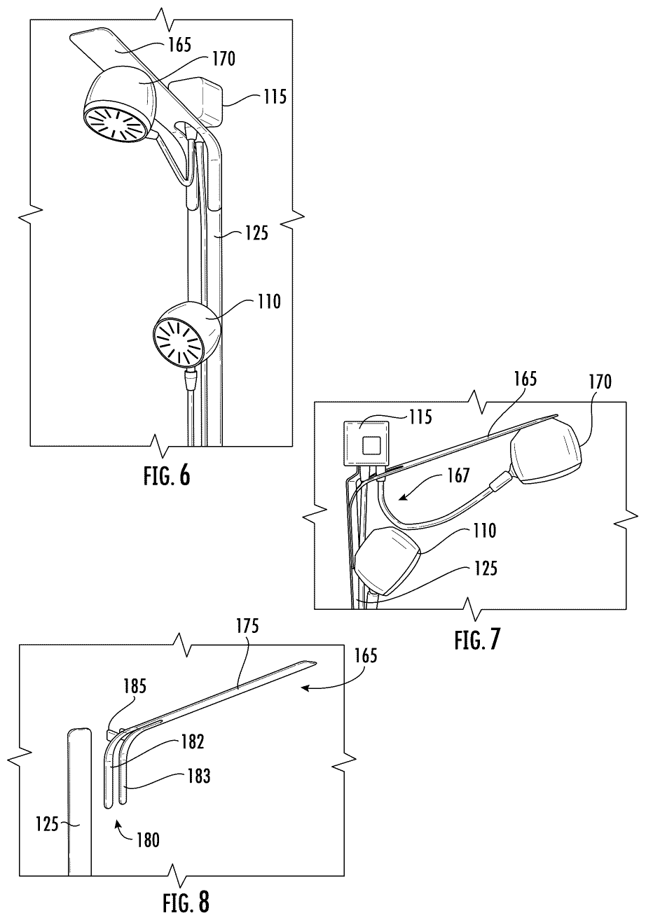

As shown in FIG. 7, the support member 165 may be configured to extend outwardly from the magnetic panel 125. In various embodiments, the support member 165 may be configured to have an incline such that a distal end of the support member 165 that projects outwardly from the magnetic panel 125 has a height that is higher or lower than an end of the support member 165 contacting the magnetic panel 125. In other embodiments, the support member 165 may be configured to project outward from the magnetic panel 125 in a substantially perpendicular direction such that the distal end of the support member 165 has a substantially same or similar height as the end of the support member 165 contacting the magnetic panel 125. Accordingly, the support member 165 may enable for positional adjustability of the spray heads 110 and/or 170 in two directions (e.g., vertical and horizontal).

As shown in FIG. 8, the support member 165 may include a first portion 175 and a second portion 180, where the first portion 175 projects outward from the magnetic panel 125 and the second portion 180 is substantially parallel to the magnetic panel 125. At least one magnet 185 may be coupled to the second portion 180 and/or to a joint formed between the first and second portions 175, 180, where the at least one magnet 185 is configured to facilitate coupling of the support member 165 to the magnetic panel 125. In various embodiments, the first portion 175 is configured as a cantilever, supported by the second portion 180. Although FIG. 8 shows the support member 165 is substantially plate-like (i.e., having a thickness substantially smaller than a width thereof), the support member 165 may be configured as any shape suitable for coupling to the magnetic panel 125 and extending outward therefrom to enable adjustable positioning of the spray head 110 and/or 170.

In various embodiments, the second portion 180 of the support member 165 includes one or more features configured to enable the support member 165 to fit around one or more fluid conduits within the handshower assembly 100. For example, as shown in FIG. 8, the second portion 180 includes a first prong 182 and a second prong 183, where the prongs 182, 183 are separated by a gap, and where the gap allows for fluid conduits 167 (shown in FIG. 7) extending between the water supply 115 and the spray heads 110 and/or 170 to pass through the support member 165. In various embodiments, the first prong 182 and second prong 183 may be conjoined such that the second portion 180 includes a single contiguous member. In yet other embodiments, the prongs 182, 183 may be separate in one region and conjoined in another such that the second portion 180 includes at least one aperture through which the fluid conduits 167 may pass. In some embodiments, the support member 165 may be configured such that the first portion 175 is a separate component configured for coupling to the second portion 180. In other embodiments, such as shown in FIG. 8, the first and second portions 175, 180 are integrally formed. In various embodiments, an angle between the first and second portions 175, 180 may be set based on a desired range of adjustability of the spray heads 110 and/or 170. In other embodiments, an angle between the first and second portions 175, 180 may be adjustable.

In various embodiments, the spray head 110 (and/or the spray head 170) may be configured to facilitate not only translational adjustability within the shower area (e.g., horizontal and vertical adjustability), but also angular adjustability. It should be noted that although FIGS. 9-14 show the features of the spray head 110, such features are equally applicable to the spray head 170. As illustrated in FIG. 9, the spray head 110 is fluidly coupled to the water supply 115 via a hose 190. The spray head 110 includes a body 195 having a spray face 200, where water from the water supply 115 delivered to the spray head 110 through the hose 190 exits the spray head 110 through a plurality of apertures (e.g., slots, holes, nozzles, etc.) 205 disposed within the spray face 200. The body 195 includes one or more magnets or magnetic components to facilitate coupling of the spray head 110 to the water supply 115 (i.e., to an outer housing thereof), and/or the magnetic panel 125 (and/or to the magnetic panels, 130, 137).

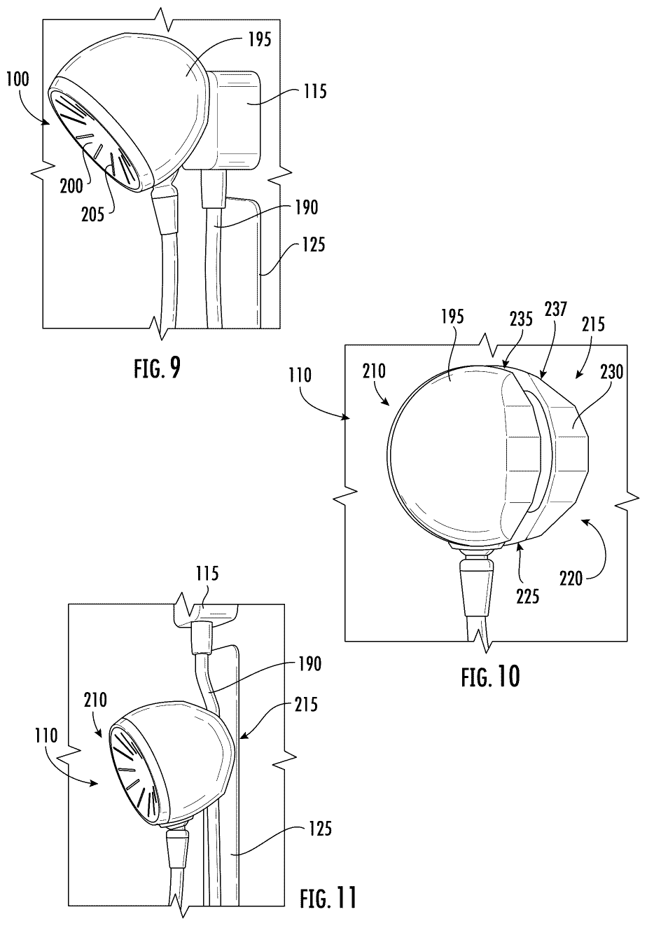

The spray head 110 includes a front portion 210 and a rear portion 215, where the spray face 200 is disposed within or near the front portion 210. As shown in FIG. 10, the rear portion 215 includes a magnetic region 220 disposed within the body 195, where the magnetic region 220 includes a plurality of magnetic surfaces 230. In various embodiments, each magnetic surface 230 includes, consists of, or is adjacent to a magnet or magnetic material enabling each surface 230 to be configured for coupling to one or more magnetic panels (e.g., panels 125, 130, 137) and/or support structures (e.g., support member 165) within the handshower assembly 100. In various embodiments, each of the surfaces 230 are arranged at varying angles relative to a central axis of the spray head 110 such that coupling the spray head 110 to a magnetic surface within the shower area (e.g., panels 125, 130, 137 and/or support member 165) via one of the surfaces 230 couples the spray head 110 at an angle determined by the surface 230.

In various embodiments, the magnetic region 220 of the spray head 110 includes a first portion 235 and a parallel second portion 237, where the portions 235, 237 are separated by a gap or slot 225, as shown in FIG. 10. Each of the first and second portions 235, 237 include a plurality of magnetic angled surfaces 230, where each angled surface 230 is substantially planar such that coupling the spray head 110 to a magnetic surface within the shower area via one of the surfaces 230 on either of the portions 235, 237 couples the spray head 110 at an angle determined by the surface 230. The angled surfaces 230 allow a user to customize a spray angle of the spray head 110, such as to adjust for a height of the user. For example, each of the portions 235, 237 may include five angled surfaces 230, which enables the spray head 110 to be mounted at five different angles within the handshower assembly 100. Various embodiments of the spray head 110 may include any number of angled surfaces 230 (e.g., 2, 4, 6, 15, etc.). In various embodiments, the slot 225 between the portions 235, 237 enables the spray head 110 to be mounted within the shower area while accommodating the hose 190, as shown in FIG. 11. For example, the spray head 110 may be mounted to the magnetic panel 125 at a position below and axially aligned with the water supply 115, where the hose 190 of the spray head 110 fits within the slot 225 to allow the spray head 110 to be securely and compactly coupled within the handshower assembly 100.

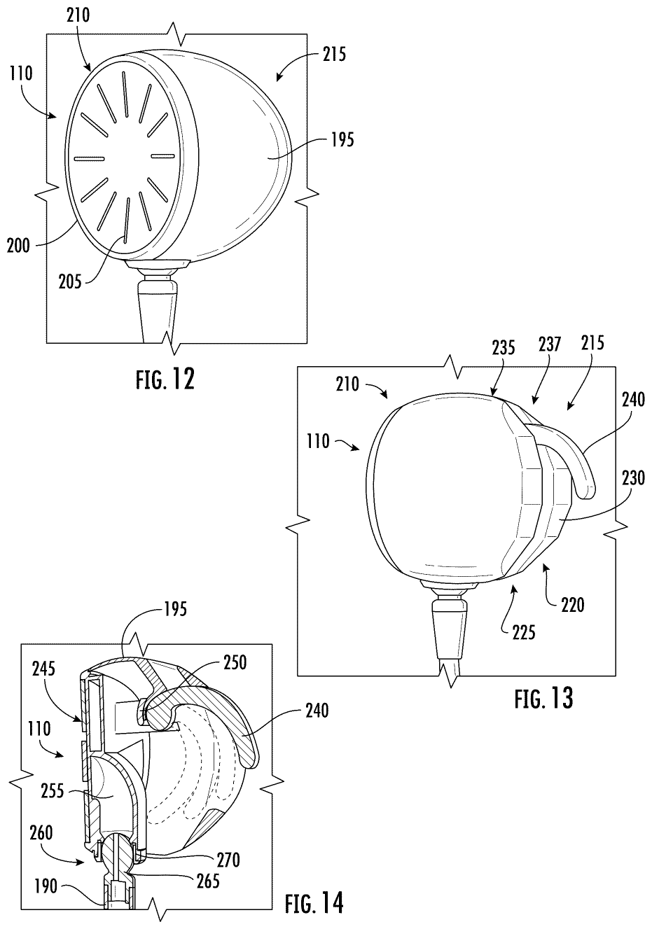

In various embodiments, the spray head 110 may include one or more features to facilitate ease of handling by a user. As shown in FIG. 12, the spray head 110 may be configured to have a size and shape such that the body 195 may fit within the palm of a user. In various embodiments, the body 195 may include one or more external grip features, such as contouring, surface treatments, and/or grip-enhancing overlays to facilitate ease of handling by the user. In some embodiments, the spray head 110 includes one or more handles, as shown in FIGS. 13 and 14. As illustrated, the spray head 110 may include a handle 240 disposed within the rear portion 215. The handle 240 may be configured such that a user's hand may fit between the body 195 and the handle 240 to facilitate secure handling of the spray head 110. In some embodiments, the handle 240 may be hingedly coupled to the body 195 at a pin joint 250 disposed within the slot 225 such that the handle 240 may articulate relative to the body 195. In some embodiments, the handle 240 may be extendable or retractable such that the handle 240 may be stowed within the body 195 when the spray head 110 is mounted (e.g., to one of the panels 125, 130, 137) or when not in use, and the handle may be extended from the body 195 when the spray head 110 is used as a handheld showerhead within the assembly 100. In various embodiments, the handle 240 may be arcuate such that the handle 240 conforms or caresses a user's hand when the spray head 110 is being handled.

FIG. 14 shows a cross-sectional view of the spray head 110 taken along an axis defined by the slot 225. As shown, the handle 240 is coupled to a structural member 245 within the body 195 at a pin joint 250. In various embodiments, the pin joint 250 may be fitted with one or more damping mechanisms to control a rate of expansion or retraction of the handle 240. In some embodiments, the pin joint 250 may be fitted with a lock and release mechanism configured to controllably lock the handle 240 in either an expanded position or a retracted position. In various embodiments, the structural member 245 within the body 195 is integrally formed with one or more fluid pathways 255 through the spray head 110 such that water supplied to the spray head 110 from the water supply 115 flows through the hose 190 into the one or more fluid pathways 255 and out the spray face 200. As shown, the hose 190 may be coupled to the structural member 245 at a joint 260 via one or more fittings 265, which may be coupled to an opening 270.

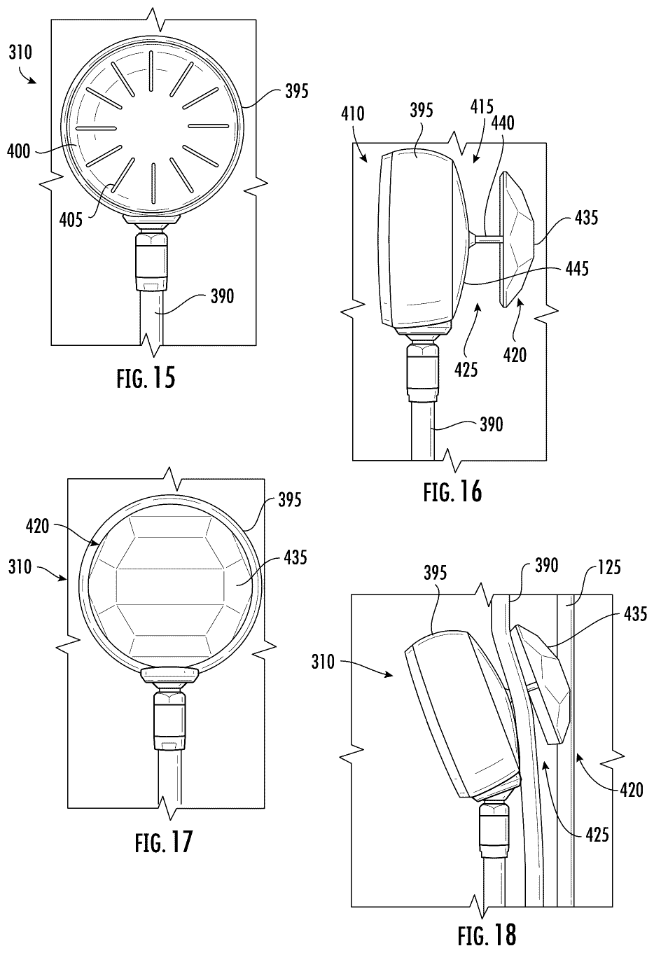

In some embodiments, the handshower assembly 100 may include one or more spray heads including one or more magnetic surfaces spaced from a body of the spray head. FIGS. 15-18 show alternate views of a spray head 310, which is compatible for use within the handshower assembly 100. In various embodiments, the spray head 310 is interchangeable with the spray head 110 (or spray head 170) within the handshower assembly 100. In some embodiments, the handshower assembly 100 may include at least one spray head 110 and at least one spray head 310.

As shown, the spray head 310 includes a hose 390, which is configured to deliver water (e.g., from the water supply 115) to the spray head 310. The hose 390 is fluidly coupled to a body 395, which is further coupled to a spray face 400 having a plurality of apertures 405 (e.g., holes, slots, nozzles, etc.) disposed therein, where the apertures 405 are configured to facilitate output of water from the spray head 310. The spray head 310 includes a front region 410 and a rear region 415, where the spray face 400 is disposed within or near the front region 410. The rear region 415 includes a rear face 445. A magnetic component 420 is coupled to the rear face 445 via a support member or arm 440 (e.g., pin) extending therebetween. The rear face 445 is separated from the magnetic component 420 to define a space 425 therebetween. In various embodiments, a face of the magnetic component 420 is substantially parallel to the rear face 445. The magnetic component 420 is configured to facilitate coupling of the spray head 310 to one or more surfaces (e.g., the magnetic panels 125, 130, 137) within the handshower assembly 100.

The magnetic component 420 includes a plurality of magnetic angled surfaces 435, where each angled surface 435 is substantially planar and is disposed at a different angle relative to an adjacent angled surface 435. In various embodiments, each magnetic angled surface 435 includes, consists of, or is adjacent to a magnet or magnetic material enabling each angled surface 435 to be configured for coupling to one or more magnetic panels (e.g., panels 125, 130, 137) and/or support structures (e.g., support member 165) within the handshower assembly 100. In various embodiments, each of the angled surfaces 435 are arranged at varying angles relative to a central axis of the spray head 310 such that coupling the spray head 310 to a magnetic surface within the shower area (e.g., panels 125, 130, 137 and/or support member 165) via one of the angled surfaces 435 couples the spray head 310 at an angle determined by the surface 435.

Such an arrangement enables customization of the spray head 310 position within a bathing space. Accordingly, a user of the handshower assembly 100 may couple the spray head 310 at a particular angle via the angled surfaces 435 to result in a desired spray angle or to accommodate the user's height, etc.

For example, the magnetic component 420 may include eleven surfaces 435, which enables the spray head 310 to be mounted at eleven different angles within the handshower assembly 100. Various embodiments of the spray head 310 may include any number of surfaces 435 (e.g., 2, 4, 6, 15, etc.). In various embodiments, the space 425 between the rear face 445 and the magnetic component 420 to be mounted within the shower area while accommodating the hose 390, as shown in FIG. 18. For example, the spray head 310 may be mounted to the magnetic panel 125 at a position below and axially aligned with the water supply 115, where the hose 390 of the spray head 310 fits within the space 425 to allow the spray head 310 to be securely and compactly coupled within the handshower assembly 100.

In some embodiments, the magnetic component 420 may also function as a handle to facilitate ease of use of the spray head 310. For example, a user may grasp the spray head 310 by inserting their hand between the body 395 and the magnetic component 420. Although the spray head 310 is shown in FIGS. 15-18 as being generally cylindrical in shape, the spray head 310 may be spherical, oblong, rectangular, or any other shape configured to facilitate ease of use of the spray head 310.

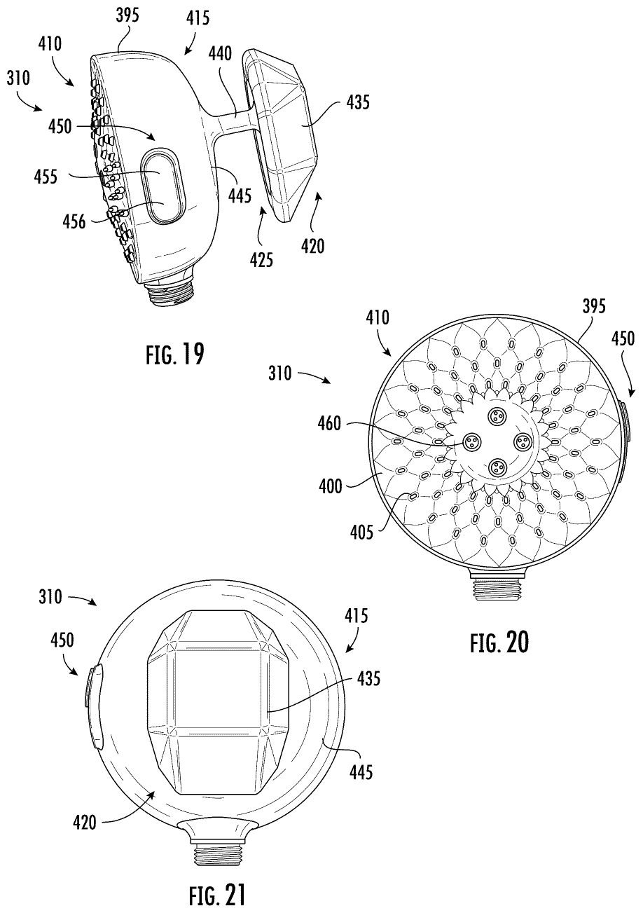

In various embodiments, the spray head 310 may also include one or more controls 450 disposed on the body 395. For example, as shown in FIGS. 19-21, the spray head 310 may include controls 450 disposed on a side portion of the body 395, where the controls 450 may be configured to adjust a mode or characteristic of water flow from the spray head 310. Although FIG. 19 shows the controls 450 including a first button 455 and a second button 456, in various embodiments, the controls 450 may include one button, more than two buttons, any number of knobs, dials, levers, or other controllers known in the art. In some embodiments, the spray head 310 may configured to provide more than one spray or flow profile of water. As shown in FIG. 20, the spray face 400 is structured such that the apertures 405 (e.g., holes, slots, nozzles, etc.) are arranged about an outer portion of the spray face 400, where the apertures 405 substantially surround a second plurality of apertures 460 (e.g., holes, slots, nozzles, etc.) disposed within a central portion of the spray face 400. In some embodiments, the apertures 405 are configured to provide a flow of water out of the spray head 310 having a first spray profile (e.g., flow rate, flow type, etc.) and the apertures 460 are configured to provide a flow of water having a second spray profile. In some embodiments, the controls 450 are configured to cause flow of water through the apertures 405 and/or the apertures 460. For example, in some embodiments, the first button 455 may be configured to cause water flow through the apertures 405 and the second button 460 may be configured to cause water flow through the apertures 460 (or vice versa). In other embodiments, where the controls 450 include a unitary button, the unitary button (e.g., the button 455) may toggle between water flow through the apertures 405 and water flow through the apertures 460.

In various embodiments, the handshower assembly 100 may include a support member assembly 500, in addition or as an alternative to the one or more magnetic panels (e.g., panels 125, 130, 137, etc.). As shown in FIG. 22, the support member assembly 500 includes a first support member 505 and a second support member 510. As shown, the first support member 505 may configured as a hook or mount, having one or more structures to facilitate hanging, hooking, or otherwise coupling a spray head (e.g., spray head 110 and/or 310) thereto. The second support member 510 may include a first portion 515, which may be an elongated member that is coupled to or mounted within the shower space. The first portion 515 may be a magnetic panel (e.g., similar or equivalent to the panel 125, 130 and/or 137). In other embodiments, the first portion 515 may include one or more brackets, hooks, recesses, protrusions, or other features to facilitate mounting of a spray head (e.g., similar or equivalent to the spray head 110 and/or 310). The second portion 520 may include a shelf or other member extending in a direction substantially perpendicular to the first portion, where the second portion 520 is configured to facilitate mounting or storage of a spray head (e.g., spray head 110 and/or 310) and/or other components within the handshower assembly 100.

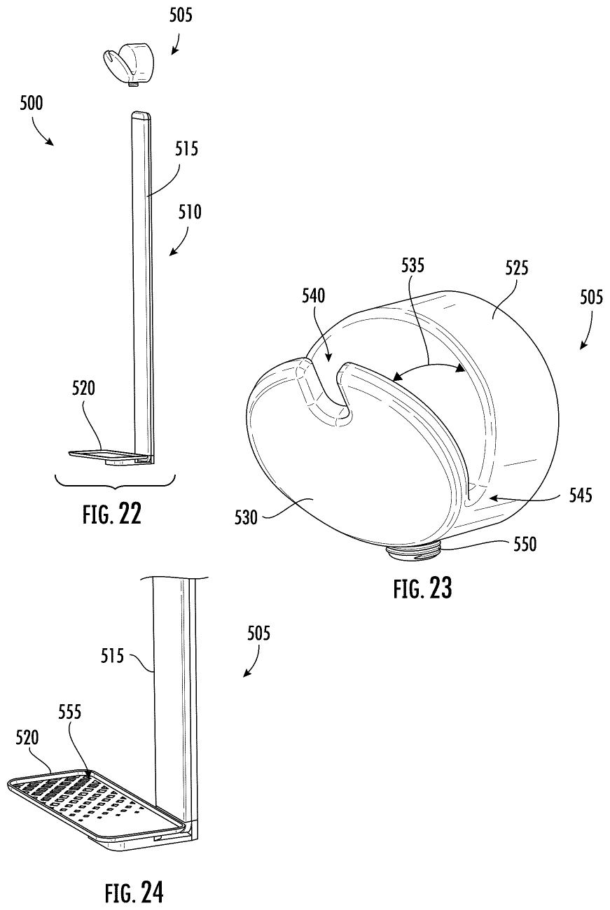

As shown in FIG. 23, the first support member 505 includes a body 525, which may be mounted within a shower space. Although FIG. 23 shows the body 525 having a generally circular shape, in various embodiments, the body 525 may have any suitable shape known in the art. The body 525 may be coupled to or integrally formed with a protruding member 530 at a joint 545 disposed at a bottom portion of the body 525 and the protruding member 530. The protruding member 530 extends away from the body 525 at an angle 535. In various embodiments, the protruding member 530 may have a same or similar cross-section as the body 525. As shown, the protruding member 530 may include a notch or groove 540 disposed within a portion of the protruding member 530 opposite the joint 545. Accordingly, in some embodiments, the groove 540 may facilitate hooking or hanging of the spray head 110 (e.g., via the handle 240) and/or the spray head 310 (e.g., via the support member or arm 440). In various embodiments, the protruding member 530 may be adjustable relative to the body 525 such that the angle 535 may be increased or decreased to accommodate mounting of a spray head to the support member 505.

In some embodiments, as shown in FIG. 23, the first support member 505 may be fluidly coupled to a water supply. Accordingly, the first support member 505 may include a coupling or port 550 disposed on the body 525 to facilitate attachment of a hose (e.g., hose 190 and/or 390) or other conduit that may be configured to fluidly couple a spray head (e.g., spray head 110 and/or 310) to the body 525. As shown in FIG. 24, the second support member may be configured such that the second portion 520 is structured as a shelf to facilitate storage and/or mounting of one or more components of the handshower assembly 100. In various embodiments, the second portion 520 may extend outwardly from the first portion 515 in a substantially perpendicular direction. For example, as shown in FIG. 24, the second portion 520 extends outwardly in two directions, which are perpendicular to the first portion 515. In other embodiments, the second portion 520 may be permanently coupled to the first portion 515 (e.g., integrally formed or via an inseparable connection). In yet other embodiments, the second portion 520 may be removably coupled to the first portion 515, such as via one or more fasteners, interference fits, magnetic connections, etc. As shown in FIG. 24, the second portion 520 may include a surface texture 555. In various embodiments, the surface texture 555 may include a plurality of apertures disposed through the second portion 520 to facilitate drainage and prevent accumulation of moisture or other debris on the second portion 520. In other embodiments, the second portion 520 may include a plurality of protrusions or recesses (e.g., ridges, bumps, grooves, etc.) to facilitate retention of one or more objects (e.g., bathing accessories, components of the handshower assembly 100, etc.) thereon.

In any of the aforementioned embodiments, the handshower assembly 100 may be used by first installing one or more magnetic panels (e.g., panels 125, 130, 137) within a shower area. Each of the panels may be positioned and oriented based on a desired amount of adjustability or customizability of the handshower assembly 100. At least one spray head (e.g., spray head 110 and/or spray head 310) may then be fluidly coupled to a water source (e.g., water source 115), such that water temperature and/or flow through the spray head is controllable via a controller (e.g., controller 120). In various implementations, one or more shelving units (e.g., shelving units 135, 140) may be magnetically coupled to the one or more panels. Alternatively or additionally, one or more support members (e.g., support member 165) may be magnetically coupled to the one or more panels. Accordingly, during use of the handshower assembly 100, the at least one spray head may be selectively coupled to one of the panels and/or support member such that the spray head may be used as either a mounted shower head (i.e., when coupled to one of the panels and/or support member) or as a handheld shower wand (i.e., when not coupled to one of the panels and/or support member), where a height or angle of the spray head may be adjustable when mounted to facilitate a customized showering experience for a user.

Notwithstanding the embodiments described above in reference to FIGS. 1-18, various modifications and inclusions to those embodiments are contemplated and considered within the scope of the present disclosure.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A spray head for a shower assembly comprising:
a front portion comprising a spray face;
a rear portion opposite the spray face, the rear portion comprising a magnetic region, wherein the magnetic region includes a plurality of magnetic angled surfaces configured to magnetically couple the spray head to a support surface at a plurality of different angles; and
a slot defined within the magnetic region, the slot configured to accommodate a fluid conduit therein.

2. The spray head of claim 1, wherein the magnetic region comprises a first portion and a second portion, the first portion disposed on a first side of the slot and the second portion disposed on a second side of the slot.

3. The spray head of claim 1, further comprising a body coupled to the spray face, wherein the magnetic region is disposed within the body.

4. The spray head of claim 3, wherein the body comprises at least one grip-enhancing overlay configured to facilitate ease of handling of the spray head.

5. The spray head of claim 3, further comprising a handle, wherein the handle is rotatably coupled to the body.

6. The spray head of claim 5, wherein the handle is retractable into the slot.

7. A shower assembly comprising:
at least one magnetic panel configured for coupling to at least one support surface within a shower area;
a water supply; and
a spray head fluidly coupled to the water supply via one or more fluid conduits, the spray head comprising:
a magnetic region comprising a plurality of angled surfaces, each of the angled surfaces configured to magnetically couple to the at least one magnetic panel; and
a slot defined within the magnetic region, the slot configured to accommodate the one or more fluid conduits therein.

8. The shower assembly of claim 7, wherein the magnetic region further comprises a first portion and a second portion, the first portion disposed on a first side of the slot and the second portion disposed on a second side of the slot.

9. The shower assembly of claim 8, wherein the spray head further comprises a body and a handle, wherein the magnetic region is disposed within the body, and wherein the handle is rotatably coupled to the body between the first portion and the second portion of the magnetic region.

10. The shower assembly of claim 9, wherein the spray head comprises a front portion having one or more water outlets and a rear portion opposite the front portion, wherein the magnetic region is disposed within the rear portion.

11. The shower assembly of claim 9, wherein the handle is arcuate.

12. The shower assembly of claim 9, wherein the handle is configured to retract into the body of the spray head.

13. The shower assembly of claim 7, wherein the at least one magnetic panel comprises a first magnetic panel and a second magnetic panel.

14. The shower assembly of claim 13, where the first magnetic panel is mounted in a vertical orientation and the second magnetic panel is mounted in a horizontal orientation.

15. The shower assembly of claim 13, wherein the at least one support surface comprises a first support surface and a second support surface, and wherein first magnetic panel is coupled to the first support surface and the second magnetic panel is coupled to the second support surface.

16. The shower assembly of claim 7, further comprising a support member structurally separate from both the at least one magnetic panel and the spray head and configured to magnetically attach to the at least one magnetic panel and provide support for the spray head, wherein the support member comprises:
a first portion extending away from the at least one magnetic panel when the support member is magnetically attached to the at least one magnetic panel, the first portion being magnetic and configured to magnetically couple to the spray head; and
a second portion attached to the first portion and comprising at least one magnet configured to couple the second portion to the at least one magnetic panel.

17. The shower assembly of claim 16, wherein the second portion comprises a first prong and a second prong spaced from the first prong, wherein a gap between the first prong and the second prong is configured to accommodate the one or more fluid conduits therein.

18. The shower assembly of claim 16, wherein the first portion is angled relative to the second portion such that a first end of the first portion is at a greater height than a height of a second end of the first portion when the support member is magnetically attached to the at least one magnetic panel, the second end being coupled to the second portion.

19. A shower assembly comprising:
at least one magnetic panel configured for coupling to at least one support surface within a shower area;
a water supply; and
a spray head fluidly coupled to the water supply via one or more fluid conduits, the spray head comprising:
a magnetic region comprising a plurality of angled surfaces, each of the angled surfaces configured to magnetically couple to the at least one magnetic panel; and
an arm extending between the magnetic region and a rear face of the spray head.

20. The shower assembly of claim 19, wherein a space between the magnetic region and the rear face is configured to accommodate the one or more fluid conduits therein.
